(19) United States
(12) Patent Application Publication
(10) Pub. No.: US 2021/0348699 A1
(43) Pub. Date: Nov. 11, 2021

(54) CLAMP WITH BAND STRAIN GAUGE ARRANGEMENT

(71) Applicant: ContiTech Techno-Chemie GmbH, Karben (DE)

(72) Inventor: Joseph Peter Schultz, Dover, NH (US)

(73) Assignee: ContiTech Techno-Chemie GmbH, Karben (DE)

(21) Appl. No.: 16/866,577

(22) Filed: May 5, 2020

(51) Int. Cl. F16L 3/233; B25B 23/142; F16B 2/08

(52) U.S. Cl. CPC F16L 3/233; F16B 2/08; B25B 23/1425

(57) ABSTRACT

One general aspect includes a band clamp installation system. The band clamp installation system also includes a band strain gauge configured to generate strain measurements of a band clamp; a securement mechanism configured to install the band clamp based on the provided strain measurements.

### FIELD

The disclosure generally relates hose clamp connections and installation for fluid conveyance.

### BACKGROUND

Hoses are often used to convey liquid from one location to another. The liquid can be oil or other fluids. The hoses can be used to fill or unload transport vehicles or vessels and the like.

Hoses generally require hose connections at each end to allow attachment to ports, tanks, and the like.

Various techniques can be used to attach hose connections to hoses, such as crimping fittings, using a mechanical band clamp, and the like.

The band clamp is typically used by placing a band over a hose and fitting and reducing a band diameter to tighten the band around the fitting or joint. One common technique is to use a screw that pulls the band tighter as its diameter decreases.

However, the band clamp technique can result in poor connections. For example, the band can bind on a material or protuberance and not fit tightly enough about the fitting joint. Further, a screw and thread mechanism that performs the tightening can degrade and bind during installation, also preventing the band from properly fitting around the joint.

What is needed are techniques to form proper and tight connections of hoses to hose ends and the like.

### BRIEF DESCRIPTION OF THE DRAWINGS

FIG. 1 is a diagram illustrating a band clamp installation system 100 in accordance with one or more embodiments.

FIG. 2 is a diagram illustrating a band clamp assembly 200, 112 in accordance with one or more embodiments.

FIG. 3 is a diagram illustrating a band clamp installation system 300 in accordance with one or more embodiments.

FIG. 4 is a flow diagram illustrating a method 400 of installing a band clamp assembly 112 in accordance with one or more embodiments.

### DETAILED DESCRIPTION

The following description of the variations is merely illustrative in nature and is in no way intended to limit the scope of the disclosure, its application, or uses. The description is presented herein solely for the purpose of illustrating the various embodiments of the disclosure and should not be construed as a limitation to the scope and applicability of the disclosure. In the summary of the disclosure and this detailed description, each numerical value should be read once as modified by the term “about” (unless already expressly so modified), and then read again as not so modified unless otherwise indicated in context. Also, in the summary of the disclosure and this detailed description, it should be understood that a value range listed or described as being useful, suitable, or the like, is intended that any and every value within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific, it is to be understood that inventors appreciate and understand that any and all data points within the range are to be considered to have been specified, and that inventors had possession of the entire range and all points within the range.

Unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of concepts according to the disclosure. This description should be read to include one or at least one and the singular also includes the plural unless otherwise stated.

The terminology and phraseology used herein is for descriptive purposes and should not be construed as limiting in scope. Language such as “including,” “comprising,” “having,” “containing,” or “involving,” and variations thereof, is intended to be broad and encompass the subject matter listed thereafter, equivalents, and additional subject matter not recited.

Also, as used herein any references to “one embodiment” or “an embodiment” means that a particular element, feature, structure, or characteristic described in connection with the embodiment is included in at least one embodiment. The appearances of the phrase “in one embodiment” in various places in the specification are not necessarily referring to the same embodiment.

The foregoing description of the embodiments has been provided for purposes of illustration and description. Example embodiments are provided so that this disclosure will be sufficiently thorough, and will convey the scope to those who are skilled in the art. Numerous specific details are set forth such as examples of specific components, devices, and methods, to provide a thorough understanding of embodiments of the disclosure, but are not intended to be exhaustive or to limit the disclosure. It will be appreciated that it is within the scope of the disclosure that individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Also, in some example embodiments, well-known processes, well-known device structures, and well-known technologies are not described in detail. Further, it will be readily apparent to those of skill in the art that in the design, manufacture, and operation of apparatus to achieve that described in the disclosure, variations in apparatus design, construction, condition, erosion of components, gaps between components may present, for example.

Examples can include subject matter such as a method, means for performing acts or blocks of the method, at least one machine-readable medium including instructions that, when performed by a machine cause the machine to perform acts of the method or of an apparatus or system for concurrent communication using multiple communication technologies according to embodiments and examples described herein.

Hoses are often used to convey liquid from one location to another. The liquid can be oil or other fluids. The hoses can be used to fill or unload transport vehicles or vessels and the like.

Hoses generally require hose connections at each end to allow attachment to ports, tanks, and the like.

Various techniques can be used to attach hose connections to hoses, such as crimping fittings, using a mechanical band clamp, and the like.

The band clamp is typically used by placing a band over a hose and fitting and reducing a band diameter to tighten the band around the fitting or joint. One common technique is to use a screw that pulls the band tighter as its diameter decreases.

However, the band clamp technique can result in poor connections. For example, the band can bind on a material or protuberance and not fit tightly enough about the fitting joint. Further, a screw and thread mechanism that performs the tightening can degrade and bind during installation, also preventing the band from properly fitting around the joint.

Mechanical band clamps are used to manage the connection of hoses to spigots or hose connections. These clamps typically include a band of material (usually a metal like stainless steel or a coated steel), and a mechanism for reducing the band diameter to tighten the band around the joint. Typical designs use an embossed or slotted band through which a worm drive screw is turned. The turning of the screw pulls the band tighter around a joint of the hose connection.

The turning of the screw also develops a measurable torque in the screw assembly. The screw assembly torque is measured during the tightening process to determine when the clamp is properly installed (i.e. a predetermined torque value is reached).

Other approaches to attach hoses to hose connections include T-bolt assemblies, other combinations of threaded fasteners to fix the clamp and the like.

These types of clamps rely on measuring the torque applied to a mechanical screw assembly or nut to ensure that the clamp is installed properly. This method is not always reliable because of defects in the mechanical assembly. These defects may cause the screw assembly to bind during installation producing an elevated torque reading—“false torque”, which is sensed by the tightening device. When this condition is sensed, the process will stop and the tightening device will indicate a «Pass» condition, although the clamp is not correctly installed at that point. Without additional extraordinary inspection processes, this condition may allow an improperly installed clamp to be accepted as “good” and passed through the process.

It is appreciated that the torque on the screw mechanism is relatively easy to measure, this measured torque value may not indicate proper installation of the mechanical band.

One or more embodiments are disclosed that utilize band strain or force to facilitate band installation. One or more embodiments of the invention measure a band force of a mechanical band during installation to install hoses to hose connections.

The embodiments include a method to measure directly the load or strain developed in the clamp band during a tightening process. This also addresses the condition of an improperly installed clamp being improperly indicated as “Good” when only measuring screw assembly torque.

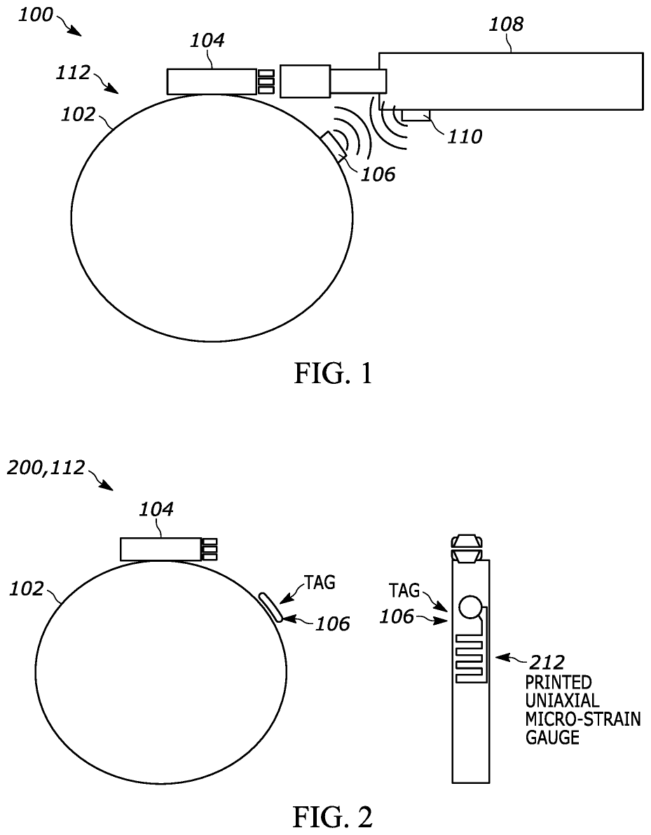

FIG. 1 is a diagram illustrating a band clamp installation system 100 in accordance with one or more embodiments. The system 100 is provided for illustrative purposes and it is appreciated that suitable variations are contemplate.

The system 100 includes a band clamp assembly 112 and a tool 108. The band clamp assembly 112 includes a band 102, a band securement 104, and a strain gauge 106. The tool 108 includes a transceiver 110.

The system 100 can be used to attach hoses to fittings and other suitable applications wherein a band clamp can be utilized to secure one object to another. Generally, a fitting is inserted into a hose, the band clamp is positioned over the hose and the fitting, then the band clamp is tightened and reduced in circumference to press against the hose and secure the hose to the fitting. Various types of hoses can be utilized, such as plastic, rubber, elastomeric, vinyl and the like. Various types of fittings can be used, such as quick connect, hose connections, spigots, and the like.

The tool 108 is configured to apply torque to the band securement 104 and cause tightening of the band 102 about or around a hose and fitting. The tool 108 can be direct current (DC) and/or alternating current (AC) powered. The tool 108 is configured to adjust power/torque to a tool end based on one or more tool inputs. The tool end, also referred to as a drive or head, has one or more size options such as, ⅜ inch square drive, ½ inch square drive, ¼ in square drive, quick connect drive, and the like. The tool end can hold various types of sockets or drivers.

The tool 108 includes one or more tool outputs to convey information.

These outputs include an audible alarm, indicators, “ok” indicators, not “ok” indicators, lights and the like.

The one or more tool inputs can include measured torque applied to the band securement, band strain, temperature and the like.

The tool 108 includes a transceiver 110 configured to receive strain measurements and the like from the gauge 106. In one example, the transceiver 110 is an RFID reader. In another example, the transceiver 110 is physically wired/connected to the gauge 106. The physically wired/connected mechanism can be configured to supply power to the gauge 106.

In one example, the tool 108 is an electric nutrunner.

The strain gauge 106 is attached and/or integrated into the band clamp 102. The strain gauge can be a separate component attached via a potting compound, 3-D printed onto the surface of the clamp during the manufacturing process, and the like. The strain gauge 106 can include one or more individual strain gauges.

The strain gauge 106 is configured to measure/generate strain or force of the band 102. These strain measurements can be provided to the tool 108 and/or other device. In one example, the strain measurements are provided by a transceiver that generates radio frequency (RF) signals. In another example, the strain measurements are provided by a wire interface or connection to the tool 108. In yet another example, the strain measurements are provided by a radio frequency identification (RFID) tag and received by an RFID reader on the tool 108.

The strain gauge 106 and the tool 108 can also be configured as an Internet of things (IoT) type device. In this example, the gauge 106 includes a unique identifier (UID) and can communicate with the tool 108 and other IoT devices over a network without requiring human-to-human or human-to-computer interaction. The gauge 106 and the tool 108 comply with the Cyber-Physical Systems architecture for Industry 4.0 and the like. The gauge 106 and the tool 108 use I smart connection level for plug and play operation and tether-free communication. The II data-to-information conversion level can be used for correlating strain measurements to tool torque and the like.

The securement 104 can include a worm screw or other type of mechanical assembly. The securement 104 is configured to selectively reduce or adjust the diameter of the band.

During operation or installation, the tool 108 drives the worm screw until the strain gauge measurement increases to a gauge threshold value and, optionally, a torque limit. At this point, the tool 108 ceases applying power or torque to the drive screw and installation of the band clamp and associated hose and fitting is completed.

In one example, the threshold value is a strain amount that indicates proper securement of a hose to a fitting. The threshold value is based on one or more of fitting size, fitting diameter, fitting material, hose size, hose diameter, hose material, band material, and the like. The gauge threshold value can be derived by empirical data.

In one example, the gauge threshold value is stored in the tool 108 and referenced by a band clamp size or type.

The torque limit is a limit on the amount of torque applied to the worm screw.

The measured strain is used to control the tightening of the clamp (the developed strain in the clamp band itself) is a value of importance to ensure that the clamp is properly installed. This can eliminate measuring the torque on the worm screw and to correlate it to a developed band load in the clamp. Further, this can improve the overall quality of the joint connection by eliminating the potential for the «false torque» readings, that can occur in the mechanical screw/band interface due to manufacturing defects.

FIG. 2 is a diagram illustrating a band clamp assembly 200, 112 in accordance with one or more embodiments. The assembly 200 is provided for illustrative purposes and it is appreciated that suitable variations are contemplate.

The assembly 200, 112 is shown in front and side views and includes the band 102, the band securement 104, and the strain gauge 106.

The side view shows a printed uniaxial micro-strain gauge 212 as the gauge 106. The gauge 212 is printed on an outer surface of the band 102.

It is appreciated that the gauge 212 can be printed on other locations of the band 102, including side surfaces, inner surface and the like.

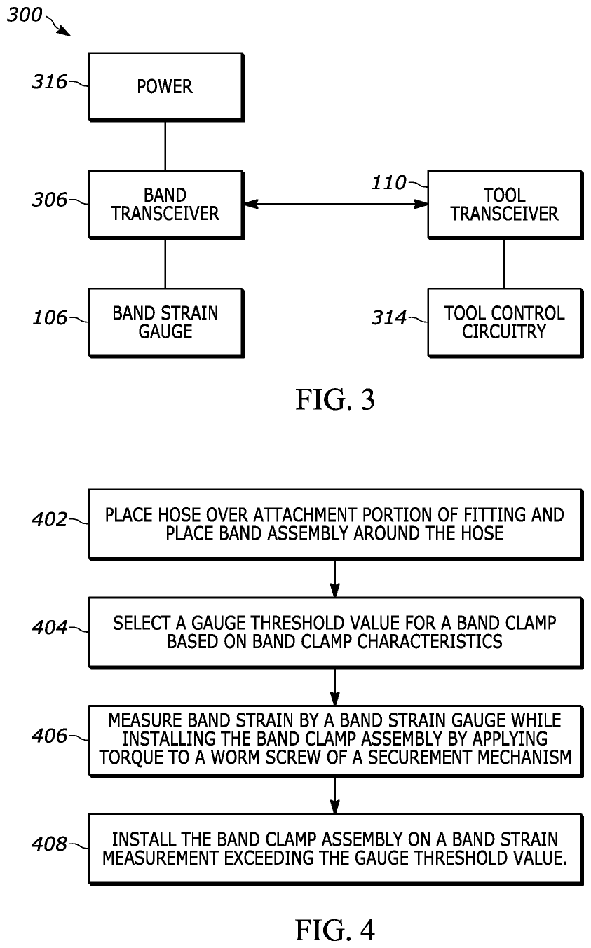

FIG. 3 is a diagram illustrating a band clamp installation system 300 in accordance with one or more embodiments. The system 300 is provided for illustrative purposes and it is appreciated that suitable variations are contemplate.

The system 300 can be and/or include the system 100 described above.

The system 300 is utilized with the band assembly 112, 200 and the like.

The system 300 includes the band strain gauge 106, a band transceiver 306, the tool transceiver 110, tool control circuitry 314 and a power supply 316.

The power supply 316 is configured to supply suitable power to the various elements of the system 300. The power supply 316 can be a primary battery, secondary battery, mains power and the like. In one example, the power supply 316 is a battery or capacitor attached to the band 102.

The strain gauge 106, as described above, is configured to measure strain of the band 102. The strain gauge 106 is further configured to provide strain measurements to the band transceiver 306.

The band transceiver 306 is configured to transmit the strain measurements from the gauge 106. The band transceiver 306 can utilize one or more suitable protocols compatible with RFID, IoT, 5G and the like. The band transceiver 306 can also provide band identification for the band 102 and include information such as, but not limited to, band size, band material and the like. The band transceiver 306 can also receive information from the tool 108 and/or other devices. The received information can include, for example, tool identification, band configuration data, and the like.

The band transceiver 306 can be integrated or located with the strain gauge 106. Alternately, the transceiver 306 can be as a separate component or circuitry located or embedded on/in the band 102.

The tool transceiver 110 is configured to receive the strain measurements from the gauge 106 by way of the band transceiver 306. The tool transceiver 110 can utilize one or more suitable protocols compatible with RFID, IoT, 5G and the like. The transceiver 110 can also provide tool identification for the tool 108 and include information such as, but not limited to, brand, torque settings, and the like. The tool transceiver 110 can also receive information from the band assembly 112, 200 and/or other devices. The received information can include, for example, band identification, band configuration data, and the like.

The tool control circuitry 314 is configured to install the band clamp assembly 112 based on at least the strain measurements from the strain gauge 106. The circuitry 314 causes a torque/rotation force to be applied to a worm screw or the like of the securement 104 causing tightening/reducing of the band 102. The force is adjusted based on the strain measurements.

Once the strain measurements reached the gauge threshold value, the band 102 is secure against the hose, fitting and/or the like.

The circuitry 314 can also utilize the torque force applied by the tool and adjust the force applied based on a measured torque.

The circuitry 314 can also be configured to determine the gauge threshold value based on the band identification, band material, band length, band width, band thickness and the like.

FIG. 4 is a flow diagram illustrating a method 400 of installing a band clamp assembly 112 in accordance with one or more embodiments. The method 400 is provided for illustrative purposes and it is appreciated that suitable variations are contemplated.

The method 400 can be performed using the systems 100, 300 and variations thereof. Circuitry and/or one or more processors and the like can be used to implement one or more blocks of the method 400.

A hose is placed over an attachment of a fitting and a band assembly 112, 200 is placed around the hose and over the attachment at block 402.

The hose is comprised of a hose material, such as an elastomeric material (rubber), plastic, vinyl, and the like.

The fitting is comprised of a fitting material, such as metal, brass, steel, poly vinyl chloride, and the like.

A gauge threshold value for the band clamp assembly 112, 200 is selected at 404 based on band clamp characteristics.

The gauge threshold value is a strain amount that indicates proper securement of a hose to a fitting. The threshold value is based on one or more of fitting size, fitting diameter, fitting material, hose size, hose diameter, hose material, band material, and the like. The gauge threshold value can be derived by empirical data.

A torque threshold value can also be selected. The torque threshold value is an amount of torque that can indicate that the proper securement individually and/or in combination with the gauge threshold value.

Measure band strain by a strain gauge 212 while installing the band clamp assembly 112, 200 at block 406.

In one example, installing is performed by applying torque to a worm screw of a securement mechanism 104. It is appreciated that other suitable techniques of using or adjusting the securement mechanism to tighten and/or install the band 102 are contemplated.

The band strain is measured while installing the band 102. Additionally, the torque used is also measured.

Completing the installation of the band clamp assembly 112, 200 upon a measured strain gauge exceeding the selected gauge threshold value at block 408.

The installing or tightening of the band 102 continues until the selected gauge threshold value and/or the torque threshold value is reached.

It should be added that ‘having’ does not exclude other elements or steps and ‘one’ or ‘one’ does not exclude a multitude. It should also be noted that characteristics described with reference to one of the above examples of execution can also be used in combination with other characteristics of other examples of execution described above. Reference signs in the claims are not to be regarded as a restriction.

As used herein, the term “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. In some embodiments, the circuitry may be implemented in, or functions associated with the circuitry may be implemented by, one or more software or firmware modules. In some embodiments, circuitry may include logic, at least partially operable in hardware.

As it employed in the subject specification, the term “processor” can refer to substantially any computing processing unit or device including, but not limited to including, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit, a digital signal processor, a field programmable gate array, a programmable logic controller, a complex programmable logic device, a discrete gate or transistor logic, discrete hardware components, or any combination thereof designed to perform the functions and/or processes described herein. Processors can exploit nano-scale architectures such as, but not limited to, molecular and quantum-dot based transistors, switches and gates, in order to optimize space usage or enhance performance of mobile devices. A processor may also be implemented as a combination of computing processing units.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner”, “adjacent”, “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

One general aspect includes a band clamp installation system. The band clamp installation system also includes a band strain gauge configured to generate strain measurements of a band clamp; a securement mechanism configured to install the band clamp based on the provided strain measurements.

Implementations may include one or more of the following features. The system may include a band transceiver configured to transmit the generated strain measurements to a tool. The system may include a power supply configured to supply power to the band strain gauge. The band strain gauge is a printed strain gauge on the band clamp. The securement mechanism is a worm screw driven mechanism configured to reduce a diameter of the band clamp in response to torque force. The system may include control circuitry configured to apply a torque force to the securement mechanism based on the generated strain measurements. The control circuitry is further configured to apply the torque force based on a measured torque applied to the securement mechanism. The control circuitry is further configured to determine a gauge threshold value based on characteristics of the band clamp. The characteristics may include band material, band length, band width and band thickness. The control circuitry is configured to control a dc motor of a tool based on the strain measurements. The system may include a tool configured to apply torque to the securement mechanism based on the generated strain measurements. The tool may include a receive configured to receive the generated strain measurements using RFID. Implementations of the described techniques may include hardware, a method or process, or computer software on a computer-accessible medium.

One general aspect includes a band clamp installation system. The band clamp installation system also includes a first end of a tool configured to apply torque to a securement mechanism of a band clamp assembly; a tool transceiver configured to receive band strain measurements from the band clamp assembly, and circuitry configured to adjust the applied torque by the first end based on the received band strain measurements.

Implementations may include one or more of the following features. The system where the first end of the tool may include a square head drive. The system may include a dc motor configured to generate the applied torque by the first end. The circuitry is configured to halt the applied torque on the received band strain measurements exceeding a gauge threshold value. The circuitry is configured to generate a gauge threshold value based on band clamp characteristics. Implementations of the described techniques may include hardware, a method or process, or computer software on a computer-accessible medium.

One general aspect includes a method of installing a band clamp assembly. The method of installing also includes selecting a gauge threshold value for a band clamp based on band clamp characteristics. The method of installing also includes measuring band strain by a band strain gauge while installing the band clamp assembly. The method of installing also includes installing the band clamp assembly on a band strain measurement exceeding the gauge threshold value.

Implementations may include one or more of the following features. The method where installing the band clamp assembly may include applying torque to a worm screw of a securement mechanism. The method may include placing a portion of a hose over an attachment portion of a fitting and placing the band assembly around the portion of the hose prior to installing the band clamp assembly. Implementations of the described techniques may include hardware, a method or process, or computer software on a computer-accessible medium.

Although a few embodiments of the disclosure have been described in detail above, those of ordinary skill in the art will readily appreciate that many modifications are possible without materially departing from the teachings of this disclosure. Accordingly, such modifications are intended to be included within the scope of this disclosure as defined in the claims.

What is claimed is:

1. A band clamp installation system comprising:
a band strain gauge configured to generate strain measurements of a band clamp; and
a securement mechanism configured to install the band clamp based on the provided strain measurements.

2. The system of claim 1, further comprising a band transceiver configured to transmit the generated strain measurements to a tool.

3. The system of claim 1, further comprising a power supply configured to supply power to the band strain gauge.

4. The system of claim 1, wherein the band strain gauge is a printed strain gauge on the band clamp.

5. The system of claim 1, wherein the securement mechanism is a worm screw driven mechanism configured to reduce a diameter of the band clamp in response to torque force.

6. The system of claim 1, further comprising control circuitry configured to apply a torque force to the securement mechanism based on the generated strain measurements.

7. The system of claim 6, wherein the control circuitry is further configured to apply the torque force based on a measured torque applied to the securement mechanism.

8. The system of claim 6, wherein the control circuitry is further configured to determine a gauge threshold value based on characteristics of the band clamp.

9. The system of claim 8, wherein the characteristics comprise band material, band length, band width and band thickness.

10. The system of claim 6, wherein the control circuitry is configured to control a DC motor of a tool based on the strain measurements.

11. The system of claim 1, further comprising a tool configured to apply torque to the securement mechanism based on the generated strain measurements.

12. The system of claim 11, wherein the tool comprises a receive configured to receive the generated strain measurements using radio frequency identification (RFID).

13. A band clamp installation system comprising:
a first end of a tool configured to apply torque to a securement mechanism of a band clamp assembly;
a tool transceiver configured to receive band strain measurements from the band clamp assembly; and
circuitry configured to adjust the applied torque by the first end based on the received band strain measurements.

14. The system of claim 13, wherein the first end of the tool comprises a square head drive.

15. The system of claim 13, further comprising a DC motor configured to generate the applied torque by the first end.

16. The system of claim 13, wherein the circuitry is configured to halt the applied torque on the received band strain measurements exceeding a gauge threshold value.

17. the system of claim 13, wherein the circuitry is configured to generate a gauge threshold value based on band clamp characteristics.

18. A method of installing a band clamp assembly, the method comprising:
selecting a gauge threshold value for a band clamp based on band clamp characteristics;
measuring band strain by a band strain gauge while installing the band clamp assembly; and
installing the band clamp assembly on a band strain measurement exceeding the gauge threshold value.

19. The method of claim 18, wherein installing the band clamp assembly comprises applying torque to a worm screw of a securement mechanism.

20. The method of claim 18, further comprising placing a portion of a hose over an attachment portion of a fitting and placing the band assembly around the portion of the hose prior to installing the band clamp assembly.
